(19) United States
(12) Patent Application Publication
(10) Pub. No.: US 2016/0297177 A1
(43) Pub. Date: Oct. 13, 2016

(54) LOW TEMPERATURE CO-FIRED CERAMIC SUBSTRATE AND METHOD OF MANUFACTURING THE SAME

(71) Applicant: SAMSUNG ELECTRO-MECHANICS CO., LTD., Suwon-si (KR)

(72) Inventors: Sin Il GU, Suwon-si (KR); Byung Woo HAN, Suwon-si (KR); Il Ho AN, Suwon-si (KR); Tae Do KWAK, Suwon-si (KR)

(21) Appl. No.: 15/013,490

(22) Filed: Feb. 2, 2016

(30) Foreign Application Priority Data
Apr. 7, 2015 (KR) 10-2015-0049003

(51) Int. Cl. B32B 18/00; B32B 37/06

(52) U.S. Cl. CPC B32B 18/00; B32B 37/06; B32B 2315/02; C04B 2237/343

(57) ABSTRACT

A method of manufacturing a low temperature co-fired ceramic substrate includes preparing an alumina sheet, and a first LTCC sheet and a second LTCC sheet containing alumina powder and glass powder; forming a low temperature co-fired ceramic substrate structure by stacking the second LTCC sheet on the alumina sheet and the first LTCC sheet on the second LTCC sheet; and firing the low temperature co-fired ceramic substrate structure. The first LTCC sheet contains a smaller amount of glass powder than the second LTCC sheet.

### CROSS-REFERENCE TO RELATED APPLICATION

This application claims the benefit of priority to Korean Patent Application No. 10-2015-0049003, filed on Apr. 7, 2015 with the Korean Intellectual Property Office, the entirety of which is incorporated herein by reference.

### TECHNICAL FIELD

The present disclosure relates to a low temperature co-fired ceramic substrate, and a method of manufacturing the same.

### BACKGROUND

In a STF (space transformer) substrate, a type of jig for semiconductor wafer inspection, positional accuracy of the substrate is very important for inspecting a semiconductor operation at a fine interval. Therefore, a LTCC (low temperature co-fired ceramic) non-shrinkage process has been used in the existing HTCC (high temperature co-fired ceramic) manufacturing process, thereby improving shrinkage control in the X-axis and Y-axis directions to improve positional accuracy. However, LTCC products have the disadvantage of having a lower degree of strength as compared with HTCC products. In particular, a non-shrinkage LTCC substrate has a disadvantage of having low strength due to a high content of glass, as compared with existing LTCC materials. Therefore, during a wafer burn-in test, a substrate may not be able to withstand the pressure applied by tens of thousands of pins, thereby developing cracks or being broken. The main defect occurring in the non-shrinkage ceramic substrate is associated with substrate cracks and breakage, and thus, it is a situation in which securing both constrained firing and strength enhancement is important.

### SUMMARY

An exemplary embodiment in the present disclosure provides a low temperature co-fired ceramic substrate having improved strength to thereby reduce defects such as cracks, and a method of manufacturing the same, in order to remedy various disadvantages and improve problems present in conventional low temperature co-fired ceramic substrates.

According to an exemplary embodiment in the present disclosure, a method of manufacturing a low temperature co-fired ceramic substrate includes preparing an alumina sheet, and a first LTCC sheet and a second LTCC sheet containing alumina powder and glass powder; stacking the alumina sheet, the second LTCC sheet, and the first LTCC sheet in order; and firing the stacked sheets, wherein the first LTCC sheet contains the glass powder in a smaller amount than the second LTCC sheet.

Herein, the alumina sheet may be used as a constraining layer restraining the substrate from shrinking in X axis and Y axis directions during the firing of the low temperature fired ceramic substrate.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a cross-sectional view of a low temperature co-fired ceramic substrate according to an exemplary embodiment in the present disclosure;

FIG. 2 is a cross-sectional view of a co-fired ceramic substrate structure after stacking an alumina sheet, a second LTCC sheet, and a first LTCC sheet in the process of manufacturing the low temperature co-fired ceramic substrate according to an exemplary embodiment in the present disclosure;

FIG. 3 is a cross-sectional view of the co-fired ceramic substrate structure during firing in the process of manufacturing the low temperature co-fired ceramic substrate according to an exemplary embodiment in the present disclosure;

FIG. 4 is a cross-sectional view of the co-fired ceramic substrate structure after firing in the process of manufacturing the low temperature co-fired ceramic substrate according to an exemplary embodiment in the present disclosure;

FIG. 5 is a cross-sectional view of a co-fired ceramic substrate structure after stacking an alumina sheet and a LTCC sheet in the process of manufacturing a conventional low temperature co-fired ceramic substrate;

FIG. 6 is a cross-sectional view of the co-fired ceramic substrate structure during firing in the process of manufacturing the conventional low temperature co-fired ceramic substrate; and

FIG. 7 is a cross-sectional view of the co-fired ceramic substrate structure after firing in the process of manufacturing the conventional low temperature co-fired ceramic substrate.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

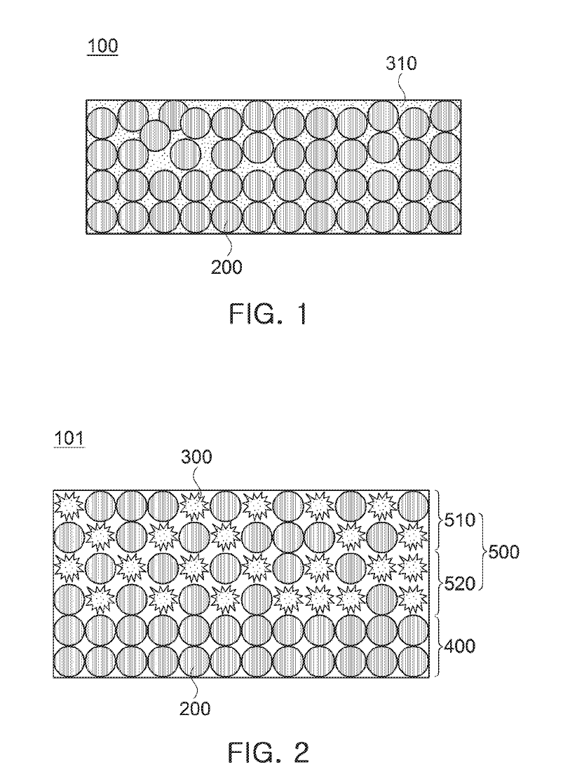

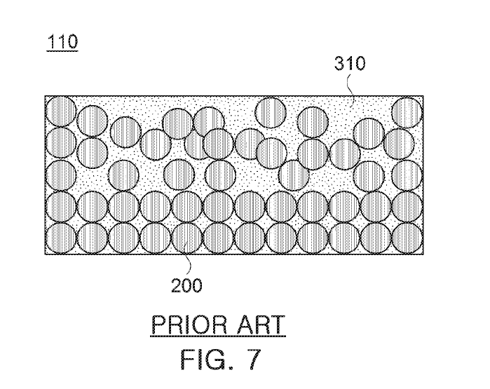

FIG. 1 is a cross-sectional view of a low temperature co-fired ceramic substrate according to an exemplary embodiment in the present disclosure. FIG. 2 is a cross-sectional view of a co-fired ceramic substrate structure after stacking an alumina sheet, a second LTCC sheet, and a first LTCC sheet in the process of manufacturing the low temperature co-fired ceramic substrate according to an exemplary embodiment in the present disclosure. FIG. 7 is a cross-sectional view of a conventional low temperature co-fired ceramic substrate.

Referring to FIGS. 1, 2 and 7, a low temperature co-fired ceramic substrate structure 101 according to an exemplary embodiment in the present disclosure may be formed by stacking an alumina sheet 400, a second LTCC sheet 520, and a first LTCC sheet 510 in order, wherein the first LTCC sheet 510 contains a smaller amount of glass powder than the second LTCC sheet 520.

More specifically, the alumina sheet 400 may be formed by adding a small amount of a binder to alumina powder 200, and the alumina powder 200 may have a particle diameter of 0.1-10 μm.

The first LTCC sheet 510 may be formed of 20-35% glass powder and 65-80% alumina powder, based on the total powder contained therein. A small amount of a binder may be added thereto, and the alumina powder may have a particle diameter of 0.1-10 μm.

The glass powder may be crystallized glass.

Further, the second LTCC sheet 520 may be formed of 35-50% glass powder and 50-65% alumina powder based on the total powder contained therein. A small amount of a binder may be added thereto, and the alumina powder may have a particle diameter of 0.1-10 μm.

The small amount of the binder contained in the alumina sheet 400, the second LTCC sheet 520, and the first LTCC sheet 510 may be removed during firing.

Since a conventional co-fired ceramic substrate 110 (FIG. 7) is sintered using a LTCC sheet formed of 35-50% glass powder and 50-65% alumina powder, similarly to the second LTCC sheet 520 of the low temperature co-fired ceramic substrate structure 101 (FIG. 2) of the present exemplary embodiment, the conventional co-fired ceramic substrate may have a glass content higher than that of the low temperature co-fired ceramic substrate 100 of the present exemplary embodiment.

Therefore, the low temperature co-fired ceramic substrate 100 of the exemplary embodiment in the present disclosure may have improved strength due to the alumina content being relatively higher than in the conventional low temperature co-fired ceramic substrate 110. Thus, when used in a STF (space transformer) substrate used as a jig for semiconductor wafer inspection, it may reduce crack and breakage defects.

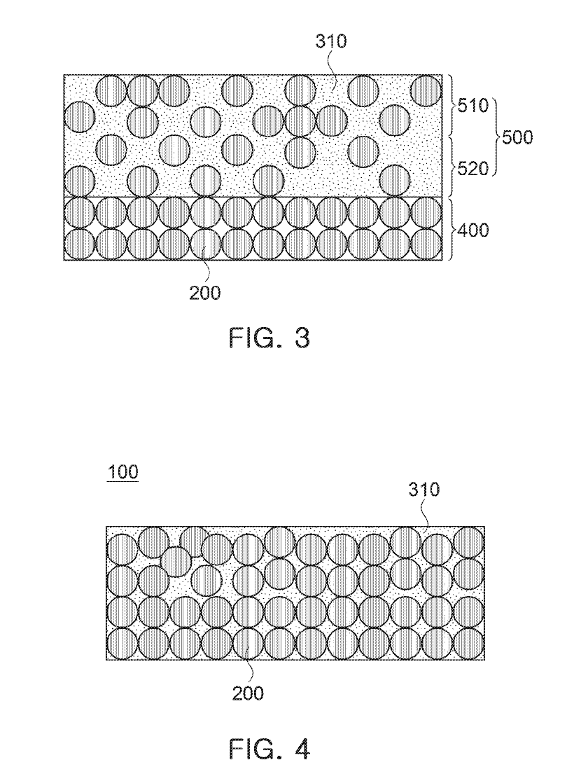

FIG. 2 is a cross-sectional view of the co-fired ceramic substrate structure after stacking the alumina sheet, the second LTCC sheet, and the first LTCC sheet in the process of manufacturing the low temperature co-fired ceramic substrate according to the exemplary embodiment in the present disclosure. FIG. 3 is a cross-sectional view of the co-fired ceramic substrate structure during firing in the process of manufacturing the low temperature co-fired ceramic substrate according to the exemplary embodiment. FIG. 4 is a cross-sectional view of the co-fired ceramic substrate structure after firing in the process of manufacturing the low temperature co-fired ceramic substrate according to the exemplary embodiment.

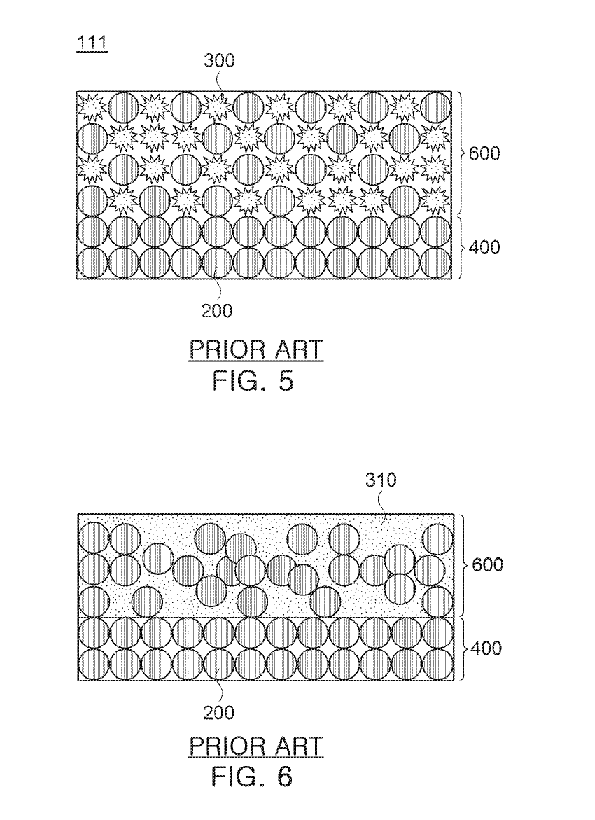

Further, FIG. 5 is a cross-sectional view of the co-fired ceramic substrate structure after stacking the alumina sheet and the LTCC sheet in the process of manufacturing the conventional low temperature co-fired ceramic substrate. FIG. 6 is a cross-sectional view of the co-fired ceramic substrate structure during firing in the process of manufacturing the conventional low temperature co-fired ceramic substrate. FIG. 7 is a cross-sectional view of the co-fired ceramic substrate structure after firing in the process of manufacturing the conventional low temperature co-fired ceramic substrate.

Referring to FIGS. 2 through 4, a method of manufacturing the low temperature co-fired ceramic substrate according to the exemplary embodiment in the present disclosure may include preparing an alumina sheet 200, and a first LTCC sheet 510 and a second LTCC sheet 520 containing alumina powder and glass powder, stacking the alumina sheet 200, the second LTCC sheet 520, and the first LTCC sheet 510 in order, and firing the stacked sheets, wherein the first LTCC sheet 510 contains a smaller amount of glass powder than the second LTCC sheet 520.

In preparing the alumina sheet 200, and the first LTCC sheet 510 and the second LTCC sheet 520 containing alumina powder and glass powder, the alumina sheet 200, the first LTCC sheet 510 and the second LTCC sheet 520 for manufacturing the low temperature co-fired ceramic substrate of the present exemplary embodiment may be manufactured.

The alumina sheet 200 may be manufactured by processing a slurry containing alumina (Al₂O₃) powder and an organic binder in a sheet shape by a common green sheet manufacturing method such as a doctor blade method.

The alumina sheet 200 may be used as a constraining layer so that the shrinkage in X-axis and Y-axis directions during the step of firing the low temperature co-fired ceramic substrate may be significantly reduced.

The first LTCC sheet 510 and the second LTCC sheet 520 may be manufactured by processing a slurry containing the alumina powder, the glass powder, and the binder in a sheet shape by a common green sheet manufacturing method such as a doctor blade method.

However, the glass content in the first LTCC sheet 510 and the second LTCC sheet 520 may be adjusted by adjusting the amounts of the alumina powder, the glass powder, and the binder contained in the first LTCC sheet 510 and the second LTCC sheet 520. In the present exemplary embodiment, the glass content of the first LTCC sheet 510 was adjusted to be lower than that of the second LTCC sheet 520.

More specifically, the alumina sheet 400 may be formed by adding a smaller amount of the binder to the alumina powder 200. The alumina powder 200 may have a particle diameter of 0.1-10 μm. The first LTCC sheet 510 may be formed of 20-35% of the glass powder and 65-80% of the alumina powder, based on a total weight of the powder. A small amount of the binder may be added thereto, and the alumina powder may have a particle diameter of 0.1-10 μm. The second LTCC sheet 520 may be formed of 35-50% of the glass powder and 50-65% of the alumina powder, based on a total weight of the powder. A small amount of the binder may be added thereto, and the alumina powder may have a particle diameter 0.1-10 μm.

In stacking the alumina sheet 200, the second LTCC sheet 520, and the first LTCC sheet 510 in order, the alumina sheet 200, the second LTCC sheet 520, and the first LTCC sheet 510 were stacked in order from the bottom to form the low temperature co-fired ceramic substrate structure 101.

In firing the low temperature co-fired ceramic substrate structure 101, the firing may be carried out at a temperature of 800° C. to 1,000° C.

Herein, the second LTCC sheet 520 having a relatively high content of the glass powder 300 is stacked in contact on the alumina sheet 200, and subsequently, the glass 310 fused in the second LTCC sheet 520 permeates the alumina sheet 200 to densify the alumina sheet 200.

Referring to FIGS. 5 through 7, in the method of manufacturing the conventional low temperature co-fired ceramic substrate, a single layer of the LTCC sheet 600 is stacked on the alumina sheet 200 and sintered. In order to densify the alumina sheet 200, an LTCC sheet 600 containing a sufficient amount of the glass powder should be used, and thus the glass content of the low temperature fired ceramic substrate after completing firing may be high.

The low temperature fired ceramic substrate for the STF (space transformer) substrate used as a jig for semiconductor wafer inspection is subject to pressure applied by tens of thousands of pins. This pressure may form cracks therein and the jig may be broken upon a burn-in test of a wafer. Thus, the strength of the low temperature fired ceramic substrate is very important. However, since the low temperature fired ceramic substrate has reduced strength with increased glass content, the low temperature co-fired ceramic substrate manufactured by the conventional manufacturing method is vulnerable to defects such as cracks.

In contrast, the low temperature fired ceramic substrate of the present exemplary embodiment has the LTCC sheet of two sheets of the first LTCC sheet 510 and the second LTCC sheet 520. The second LTCC sheet 520 stacked in contact on the alumina sheet 200 is used as a constrained sheet, and contains a relatively large amount of glass. The first LTCC sheet 510 stacked on the second LTCC sheet 520 contains a smaller amount of glass than the second LTCC sheet 520, thereby lowering the glass content of the entire low temperature fired ceramic substrate, and improving the strength of the low temperature co-fired ceramic substrate.

Accordingly, when the low temperature co-fired ceramic substrate according to the manufacturing method of the present exemplary embodiment is used in the STF (space transformer) substrate used as a jig for semiconductor wafer inspection, defects such as cracks may be significantly reduced.

As set forth above, the low temperature fired ceramic substrate according to the present disclosure is manufactured by firing a low temperature fired ceramic substrate structure wherein the LTCC sheet includes two sheets of a first LTCC sheet and a second LTCC sheet. The second LTCC sheet stacked in contact on an alumina sheet used as a constraining layer contains a relatively large amount of glass, and the first LTCC sheet stacked on the second LTCC sheet contains a smaller amount of glass than the second LTCC sheet. Thus, the glass content of the entire low temperature fired ceramic substrate may be lowered, and strength may be improved.

Accordingly, when the low temperature co-fired ceramic substrate according to the present disclosure is used in a STF (space transformer) substrate used as a jig for semiconductor wafer inspection, defects such as cracks may be significantly reduced.

While exemplary embodiments have been shown and described above, it will be apparent to those skilled in the art that modifications and variations could be made without departing from the scope of the present invention as defined by the appended claims.

What is claimed is:

1. A method of manufacturing a low temperature co-fired ceramic substrate comprising steps of:
preparing an alumina sheet, and a first LTCC sheet and a second LTCC sheet containing alumina powder and glass powder;
forming a low temperature co-fired ceramic substrate structure by stacking the second LTCC sheet on the alumina sheet and the first LTCC sheet on the second LTCC sheet; and
firing the low temperature co-fired ceramic substrate structure,
wherein the first LTCC sheet contains a smaller amount of glass powder than the second LTCC sheet.

2. The method of claim 1, wherein the alumina sheet is used as a constraining layer not allowing the first LTCC sheet and the second LTCC sheet to shrink in X axis and Y axis directions during the firing.

3. The method of claim 1, wherein the glass powder is crystallized glass.

4. The method of claim 1, wherein firing temperature is 800° C. to 1,000° C.

5. The method of claim 1, wherein the glass powder in the second LTCC sheet is fused so that the alumina sheet is permeated with the glass powder during the firing.

6. A low temperature co-fired ceramic substrate structure comprising an alumina sheet, a second LTCC sheet disposed on the alumina sheet, and a first LTCC sheet disposed on the second LTCC sheet,
wherein the first LTCC sheet contains a smaller amount of glass than the second LTCC sheet.

7. The low temperature co-fired ceramic substrate structure of claim 6, wherein:
the alumina sheet contains alumina powder and a binder,
the first LTCC sheet contains 20-35% of the glass and 65-80% of the alumina powder, based on a total weight of the first LTCC sheet, and
the second LTCC sheet contains 35-50% of the glass and 50-65% of the alumina powder, based on a total weight of the second LTCC sheet.

8. A low temperature co-fired ceramic substrate manufactured by firing the ceramic substrate structure of claim 6.
